(19) United States
(12) Patent Application Publication
(10) Pub. No.: US 2021/0152744 A1
(43) Pub. Date: May 20, 2021

(54) CONTROL DEVICE, METHOD, AND PROGRAM

(71) Applicant: SZ DJI TECHNOLOGY CO., LTD., Shenzhen (CN)

(72) Inventors: Kenichi HONJO, Shenzhen (CN); Yoshinori NAGAYAMA, Shenzhen (CN)

(21) Appl. No.: 17/161,535

(22) Filed: Jan. 28, 2021

Related U.S. Application Data
(63) Continuation of application No. PCT/CN2019/099056, filed on Aug. 2, 2019.

(30) Foreign Application Priority Data
Aug. 2, 2018 (JP) 2018-145949

(51) Int. Cl. H04N 5/232; H04N 5/225; G02B 7/09; G02B 7/36

(52) U.S. Cl. CPC H04N 5/232123; G02B 7/36; G02B 7/09; H04N 5/2254

(57) ABSTRACT

A control device includes a position detector and a controller configured to control a lens to move along an optical axis in a first direction, obtain images through the lens while the lens is moving along the optical axis in the first direction, obtain contrast evaluation values each corresponding to one of the images, obtain, via the position detector, lens positions each corresponding to one of the images, store a correspondence relationship between the contrast evaluation values and the lens positions in a memory, and in response to detecting a focus position of the lens according to the contrast evaluation values, read the correspondence relationship from the memory and control the lens to move in a second direction opposite to the first direction until the lens is moved to a lens position corresponding to the focus position.

### CROSS-REFERENCE TO RELATED APPLICATIONS

This application is a continuation of International Application No. PCT/CN2019/099056, filed Aug. 2, 2019, which claims priority to Japanese Application No. 2018-145949, filed Aug. 2, 2018, the entire contents of both of which are incorporated herein by reference.

### TECHNICAL FIELD

The present disclosure relates to a control device, a control method, and a program.

### BACKGROUND

A photographing device for shooting images uses an autofocus (AF) manner called contrast detection AF to automatically control a position of a lens to focus. In contrast detection AF, for example, a direct current (DC) motor that drives a gear that moves the lens and a rotation sensor that detects a rotation amount of the gear are used to perform autofocus control. When the DC motor drives the gear to move in one direction, the lens moves in a preset direction parallel to an optical axis. Further, when the DC motor drives the gear to move in a direction opposite to the one direction, the lens moves in a direction opposite to the preset direction.

In contrast detection AF, the following three processes are performed. A first process is a process of detecting a peak value of a contrast evaluation value of an image obtained from an imaging device while the DC motor drives the gear to move in one direction. A second process is a process in which the DC motor drives the gear to move in a direction opposite to the one direction, so that the contrast evaluation value exceeds the peak value. A third process is a process in which the DC motor drives the gear to move in the one direction, and the gear is stopped with the peak value of the contrast evaluation value as a target. Further, in contrast detection AF, the position of the lens is determined based on the rotation amount of the gear detected by the rotation sensor. In contrast detection AF, for example, because of gear backlash, focusing is performed by driving the gear in a direction to increase the contrast evaluation value. The direction is called a climbing direction, and the control of the climbing direction is called climbing control. The contrast evaluation value of the image is an evaluation value indicating strength of a contrast of the image. In this disclosure, a larger contrast evaluation value indicates a stronger contrast.

Patent Document 1 discloses a technique for detecting a position of a focus lens in an optical axis direction by a magneto resistive (MR) sensor (referring to paragraph [0039] of Patent Document 1). Patent Document 1 discloses that the MR sensor detects the position of the lens, however, it does not disclose a control of autofocus.

The MR sensor is a known sensor that uses a magneto resistive effect device, which measures the magnitude of a magnetic field through the magneto resistive effect in which an electrical resistance of a solid changes due to the magnetic field. Magneto resistive effects include an anisotropic magneto resistive (AMR) effect in which the resistance changes due to an external magnetic field, a giant magneto resistive (GMR) effect that generates giant magneto resistive effect, a tunnel magneto resistive (TMR) effect in which a tunnel current flows in a magnetic tunnel junction device due to an applied magnetic field to change the resistance, or the like.
Patent Document 1: JP Application Publication No. 2004-37121

In the photographing device, when the autofocus control based on contrast detection AF is performed, due to the gear backlash, a process of moving the gear in one direction and detecting the peak value of the contrast evaluation value is performed. Then, in the photographing device, a process of moving the gear in a direction opposite to the one direction to make the contrast evaluation value exceed the peak value is performed. Then, in the photographing device, a process of moving the gear in the one direction and stopping the gear with the peak value as the target is performed. In the photographing device, these processes are needed, therefore there are scenarios in which there are too many processes and too long time for a needed lens movement to achieve a focused state.

### SUMMARY

In accordance with the disclosure, there is provided a control device including a position detector and a controller configured to control a lens to move along an optical axis in a first direction, obtain one or more images through the lens while the lens is moving along the optical axis in the first direction, obtain one or more contrast evaluation values each corresponding to one of the one or more images, obtain, via the position detector, one or more lens positions each corresponding to one of the one or more images, store a correspondence relationship between the one or more contrast evaluation values and the one or more lens positions in a memory, and in response to detecting a focus position of the lens according to the one or more contrast evaluation values, read the correspondence relationship from the memory and control the lens to move in a second direction opposite to the first direction until the lens is moved to a lens position corresponding to the focus position.

Also in accordance with the disclosure, there is provided a control method that includes controlling a lens to move along an optical axis in a first direction, obtaining one or more images through the lens while the lens is moving along the optical axis in the first direction, obtaining one or more contrast evaluation values each corresponding to one of the one or more images, obtaining, via a position detector, one or more lens positions each corresponding to one of the one or more images, storing a correspondence relationship between the one or more contrast evaluation values and the one or more lens positions in a memory, and in response to detecting a focus position of the lens according to the one or more contrast evaluation values, reading the correspondence relationship from the memory and controlling the lens to move in a second direction opposite to the first direction until the lens is moved to a lens position corresponding to the focus position.

Also in accordance with the disclosure, there is provided a non-transitory computer-readable storage medium storing a program that, when executed by a computer, causes the computer to control a lens to move along an optical axis in a first direction, obtain one or more images through the lens while the lens is moving along the optical axis in the first direction, obtain one or more contrast evaluation values each corresponding to one of the one or more images, obtain, via a position detector, one or more lens positions each corresponding to one of the one or more images, store a correspondence relationship between the one or more contrast evaluation values and the one or more lens positions in a memory, and in response to detecting a focus position of the lens according to the one or more contrast evaluation values, read the correspondence relationship from the memory and control the lens to move in a second direction opposite to the first direction until the lens is moved to a lens position corresponding to the focus position.

### BRIEF DESCRIPTION OF THE DRAWINGS

FIG. 1 is a schematic diagram showing an external structure of a photographing device according to an embodiment of the disclosure.

FIG. 2 is a schematic diagram showing a functional configuration of a photographing device according to an embodiment of the disclosure.

FIG. 3 is a diagram for explaining autofocus processing performed by a photographing device according to an embodiment of the disclosure.

FIG. 4 is a diagram for explaining detection processing of a peak value of a contrast evaluation value performed by a photographing device according to an embodiment of the disclosure.

FIG. 5 is a diagram for explaining detection processing of a peak value of a contrast evaluation value performed by a photographing device according to an embodiment of the disclosure.

FIG. 6 is a flowchart of a process of autofocus processing performed by a photographing device according to an embodiment of the disclosure.

FIG. 7 is a diagram showing a configuration of an MR sensor and a magnetic member in a photographing device according to an embodiment of the disclosure.

FIG. 8 is a schematic diagram showing a functional configuration of another photographing device according to an embodiment of the disclosure.

FIG. 9 is a diagram of a hardware configuration of a controller and a memory.

FIG. 10 is a schematic diagram showing an unmanned aerial vehicle (UAV) and a remote operation device.

FIG. 11 is a schematic diagram for explaining contrast detection AF.

### REFERENCE NUMERALS

1, 2, 613-615—Photographing Device 11—Body 12—Lens Barrel 13—Lens 14-16—Button 17—Viewfinder 21—Rotary Cam 22—Gear Box 23—Imaging Unit 31—Lens Frame 32—Cam Groove 33—Cam Pin 41, 301—MR Sensor 42, 302—Magnetic Member 61—DC Motor 62—Gear 63—Rotation Sensor 71—Imaging Device 72—Operation Unit 73—Display Unit 74—Memory 75—Controller 81—Obtaining Circuit 82—Movement Control Circuit 83—Detection Circuit 84—Determination Circuit 85—Focusing Circuit 201-203—Point 211, 212—Straight Line 311—Guide Shaft 401—Position Detection Device 501—Computer 511—Host Controller 512—CPU 513—RAM 514—Input/Output Controller 515—Communication Interface 516—ROM 601—Unmanned Aerial Vehicle (UAV) 602—Remote Operation Device 611—UAV Body 612—Gimbal 1001—Pulse Count Characteristic 1002—Contrast Characteristic P1, P11—Detection Focus Point P2, P12, P13—Focus Point

### DETAILED DESCRIPTION OF THE EMBODIMENTS

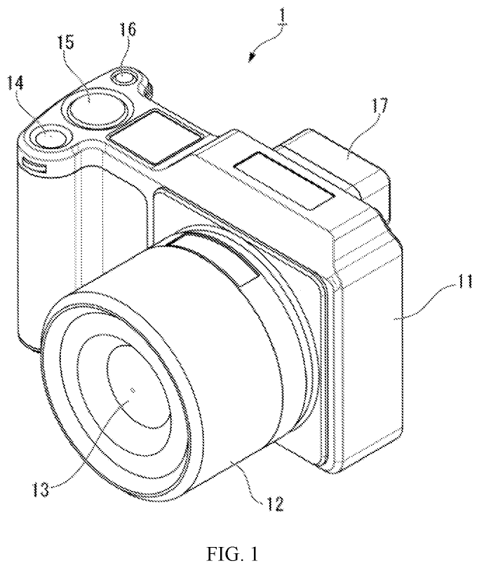

Embodiments of the present disclosure will be described with reference to the accompanying drawings. FIG. 1 is a schematic diagram showing an external structure of a photographing device 1 according to an embodiment of the disclosure. The photographing device 1 includes a body 11 and a lens barrel 12. The lens barrel 12 includes a lens 13. The body 11 includes buttons 14-16 and a viewfinder 17. The buttons 14-16 are operated by a user, and receive predetermined instructions related to, for example, power, shutter, and exposure. A structure of the photographing device 1 is not limited to the structure shown in FIG. 1, and another structure may be used.

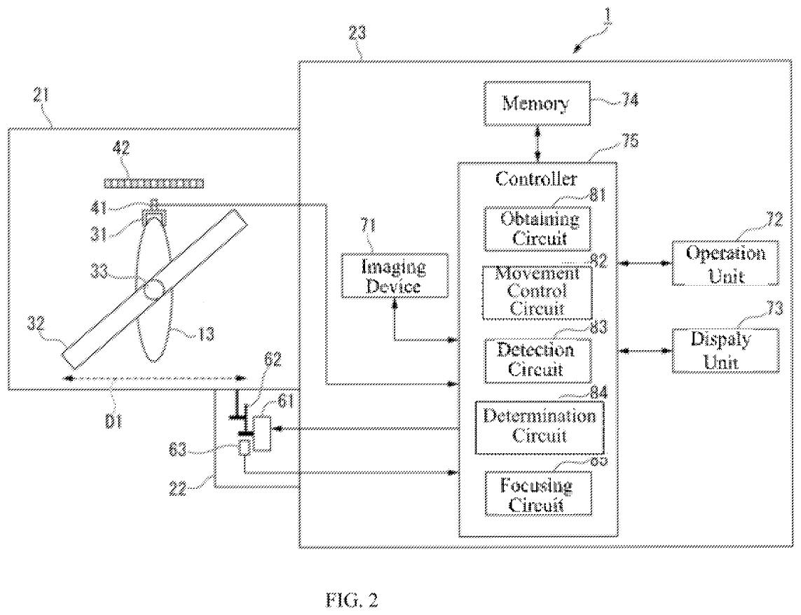

FIG. 2 is a schematic diagram showing a functional configuration of the photographing device 1 according to an embodiment of the disclosure. The lens barrel 12 of the photographing device 1 includes a lens 13, an annular rotary cam 21, a lens frame 31, a cam groove 32, a cam pin 33, an MR sensor 41, and a magnetic member 42. The body 11 of the photographing device 1 includes a gear box 22 and an imaging unit 23. The gear box 22 includes a direct current (DC) motor 61, a gear 62, and a two-phase rotation sensor 63. The imaging unit 23 includes an imaging device 71, an operation unit 72, a display unit 73, a memory 74, and a controller 75. The controller 75 includes an obtaining circuit 81, a movement control circuit 82, a detection circuit 83, a determination circuit 84, and a focusing circuit 85. Further, a device including the MR sensor 41, the controller 75, and the memory 74 is an example of a control device. In this embodiment, the photographing device 1 is also an example of the control device.

The configuration of the lens barrel 12 is described. The lens 13 is mounted at and supported by the lens frame 31. The lens 13 is fixed by the lens frame 31. The lens frame 31 is provided with cam pins 33 fitted at the cam groove 32 of the rotary cam 21. The lens frame 31 can move along the cam groove 32 through a rotation mechanism of the rotary cam 21. Therefore, the lens 13 mounted at the lens frame 31 can move along a preset axis D1. The axis D1 of the lens 13 is an axis parallel to the optical axis of the lens 13. That is, the lens 13 can move along the optical axis of the lens 13. If the rotary cam 21 rotates in a preset rotation direction, the lens 13 moves in one direction preset along the axis D1. On the other hand, if the rotary cam 21 rotates in a direction opposite to the preset rotation direction, the lens 13 moves in a direction opposite to the one direction along the axis D1. FIG. 2 shows the axis D1 of the lens 13.

The lens frame 31 is provided with a magneto resistive effect device, e.g., an MR sensor 41. In some embodiments, the MR sensor 41 is fixed at the lens frame 31. Further, the magnetic member 42 is fixed at the rotary cam 21. The magnetic member 42 has a magnetic array in which N poles (an example of first units having a first polarity) and S poles (an example of second units having a second polarity different from the first polarity) are arranged alternately along a direction parallel to the axis D1 of the lens 13. That is, the magnetic array is arranged along the optical axis of the lens 13. According to this configuration, when the lens 13 moves along the axis D1, a relative positional relationship between the MR sensor 41 and the magnetic member 42 changes. Therefore, the MR sensor 41 detects a waveform corresponding to a movement amount of the lens 13. That is, every time the polarity of the magnetic member 42 facing the position of the MR sensor 41 alternately changes in the N pole and the S pole, a pulse of a same shape is generated. Then, while the MR sensor 41 moves in the same direction, an amount of pulses generated is proportional to the movement amount of the lens 13. In some embodiments, the length of the magnetic member 42 is longer than a preset value. The preset value is a sum of a length of a movable range of the lens 13 and a length of the gear backlash caused by the movement of the lens 13. The magnetic member 42 can accurately detect the movement amount of the lens 13 by covering a portion corresponding to the preset value.

In some embodiments, the MR sensor 41 detects the amount of pulses generated as information corresponding to the movement amount. Further, in some embodiments, the MR sensor 41 detects two-phase waveforms such as a sine wave or a cosine wave as a waveform corresponding to the movement amount. Therefore, the MR sensor 41 can determine the movement amount of the lens 13 and the direction in which the lens 13 moves. The MR sensor 41 outputs information indicating the detected movement amount and movement direction to the controller 75. For information indicating the movement amount of the lens 13, for example, the movement amount, or the amount of pulses proportional to the movement amount, etc. may be used. As shown in FIG. 2, a position detector that detects the position of the lens 13 includes the magneto resistive effect device, e.g., the MR sensor 41, and the magnetic member 42. The position of a lens is also referred to as a “lens position.” Further, for the lens 13, various lenses can be used, for example, an interchangeable lens can be used.

A configuration of the gear box 22 is described. The gear 62 includes, for example, a gear link mechanism. The gear link mechanism is a mechanism in which a plurality of gears mesh. In the gear link mechanism, a position error may occur between rotation in one direction and rotation in an opposite direction. In this embodiment, for convenience of description, one gear is used for explaining. The DC motor 61 is controlled by the controller 75 to rotate the gear 62. The rotation of the gear 62 rotates the rotary cam 21, thereby forming a structure in which the lens 13 moves along the axis D1. If the gear 62 rotates along a preset rotation direction, the lens 13 moves in one direction preset along the axis D1. On the other hand, if the gear 62 rotates in a direction opposite to the preset rotation direction, the lens 13 moves in a direction opposite to the one direction along the axis D1. That is, the lens 13 is moved by the DC motor 61. Further, the lens 13 is moved by the gear link mechanism.

The rotation sensor 63 detects a rotation amount of the gear 62. The rotation sensor 63 includes, for example, a light emitter on one of both sides of the gear 62 and a light receiver on the other side. The light emitter emits light, and the light receiver receives the light. The gear 62 is provided with teeth at regular intervals along a circumference. When there is no tooth between the light emitter and the light receiver, the light from the light emitter is received by the light receiver. When there is a tooth between the light emitter and the light receiver, the light from the light emitter is blocked by the tooth and is not received by the light receiver. Therefore, the rotation sensor 63 detects a waveform corresponding to the rotation amount of the gear 62. That is, every time the tooth passes between the light emitter and the light receiver, a pulse of a same shape is generated. During the rotation of the gear 62 in a same direction, an amount of pulses generated is proportional to the rotation amount of the gear 62. Further, the rotation amount of the gear 62 is proportional to the movement amount of the lens 13.

In some embodiments, the rotation sensor 63 detects the amount of generated pulses as information indicating the rotation amount. In some embodiment, the rotation sensor 63 detects two-phase waveforms such as a sine wave or a cosine wave as a waveform corresponding to the rotation amount. Therefore, the rotation sensor 63 can determine the rotation amount of the gear 62 and the direction in which the gear 62 rotates. The rotation sensor 63 outputs information indicating the detected rotation amount and rotation direction to the controller 75.

A configuration of the imaging unit 23 is described. The imaging device 71 is provided at the optical axis of the lens 13. The imaging device 71 captures an image formed by light passing through the lens 13. The imaging device 71 outputs the captured image to the controller 75. The operation unit 72 includes a button or the like operated by the user. In some embodiments, the operation unit 72 includes buttons 14-16 shown in FIG. 1. The display unit 73 includes a screen that displays an image obtained from the imaging device 71, or the like. In some embodiments, the display unit 73 displays an image on a screen of the viewfinder 17 shown in FIG. 1. The memory 74 stores information. In some embodiments, the memory 74 is controlled by the controller 75. In some embodiments, a scenario where the imaging unit 23 includes the memory 74 is described, however, a configuration having a memory in the lens 13 or the like may also be used.

The controller 75 performs various controls related to shooting. The controller 75 perform the following controls, such as processing to receive operations on the operation unit 72, processing to display images on a screen of the display unit 73, processing to receive images from the imaging device 71, processing to store information at the memory 74, processing to delete information from the memory 74, processing to drive the DC motor 61, processing to receive information indicating the rotation amount and direction from the rotation sensor 63, and processing to receive information indicating the movement amount and direction from the MR sensor 41.

The obtaining circuit 81 obtains an image obtained by the imaging device 71. The image is displayed at the screen of the display unit 73. Further, the image is stored at the memory 74 as a captured image when a shutter button is pressed. The shutter button is, for example, button 15.

Further, the obtaining circuit 81 obtains the movement amount and movement direction detected by the MR sensor 41 from the MR sensor 41. The movement amount detected by the MR sensor 41 is not to determine an absolute position of the lens 13, but to determine a relative position of the lens 13 with respect to a preset reference position. In some embodiments, for example, information indicating the reference position is preset at the memory 74, or the reference position is detected by the controller 75 and the information indicating the reference position is stored at the memory 74. Further, besides the memory 74, a memory (not shown) can be provided inside the lens barrel 12. The memory inside the lens barrel 12 can store the same information as that stored at the memory 74. The memory inside the lens barrel 12 can store information for driving the lens 13.

The reference position can be any position. The reference position, for example, can be an end of the movable range of the lens 13. In this scenario, when the controller 75 moves the lens 13 to a position of the end and no pulse is detected by the MR sensor 41, it is determined that the lens 13 abuts the position of the end and stops. Then, the controller 75 determines the absolute position of the lens 13 based on the reference position of the lens 13 and the movement amount from the reference position. That is, when a movement amount at the reference position is set to an initial value such as 0, the movement amount represents a difference from the initial value.

Further, the controller 75 adds the amount of pulses generated when the movement direction of the lens 13 is a preset direction. On the other hand, the controller 75 subtracts the amount of pulses generated when the movement direction of the lens 13 is a direction opposite to the preset direction. Then, the controller 75 calculates a sum of these amounts of pulses as a pulse count. Therefore, the controller 75, for example, can make the pulse count indicating the movement amount from the reference position associate with the position of the lens 13 in a one-to-one correspondence.

The reference position can use another position, for example, a preset initial position of the lens 13 or a position of the lens 13 when the photographing device 1 is powered on. Further, the reference position can also be detected by any manner. For example, a light emitter that emits lights can be disposed at a portion other than the lens 13 at the reference position, a light receiver that receives lights from the light emitter can be disposed at an opposite side of the light emitter and across a movement path of the lens 13, and a blocking member that blocks lights can be disposed at a side of the lens 13. In this configuration, when the lens 13 is located at the reference position, the light from the light emitter is blocked by the blocking member and is not received by the light receiver. In this scenario, the controller 75 determines that the lens 13 is at the reference position when the light from the light emitter is not received by the light receiver. Further, the controller 75 may set a movement amount when the lens 13 is at the reference position to an initial value such as 0. Further, in some embodiments, the position of the lens 13 is represented by an absolute position that is a combination of the reference position and a movement amount, but as another example, it may be represented by a movement amount relative to the reference position. That is, in some embodiments, it is only needed to retrieve a position of the lens 13 when a peak value is obtained.

Further, the obtaining unit 81 obtains the rotation amount and the rotation direction detected by the rotation sensor 63 from the rotation sensor 63. The rotation amount detected by the rotation sensor 63 is not used to determine an absolute position of the lens 13, but to determine a relative position of the lens 13.

In some embodiments, a two-phase MR sensor 41 is used, or a three-phase MR sensor or an MR sensor having more than three phases may also be used. Further, a one-phase MR sensor can also be used. When a one-phase MR sensor is used, the movement direction of the lens 13 may be determined by the controller 75 based on the drive direction of the DC motor 61 or the like. In some embodiments, a two-phase rotation sensor 63 is used, or a three-phase rotation sensor or a rotation sensor having more than three phases may also be used. Further, a one-phase rotation sensor can also be used. When a one-phase rotation sensor is used, the movement direction of the lens 13 may be determined by the controller 75 based on the drive direction of the DC motor 61 or the like.

The movement control circuit 82 controls the drive of the DC motor 61 to move the lens 13 along the axis D1. Thus, the lens 13 moves along the axis D1. The detection circuit 83 calculates a preset contrast evaluation value for the image obtained by the obtaining circuit 81. Then, the detection circuit 83 detects a peak value of the contrast evaluation value while the lens 13 is moving in a preset direction. Further, a method of calculating the contrast evaluation value of an image may be any method. In general, the higher the contrast evaluation value of the captured image is, the closer the captured image is to a focused state.

The determination circuit 84 determines a position of the lens 13 at the time when the peak value detected by the detection circuit 83 is obtained based on the movement amount and the movement direction detected by the MR sensor 41.

In some embodiments, the controller 75 stores the information that can determine the position of the lens 13 and the information that can determine the contrast evaluation value of the image obtained by the obtaining circuit 81 at the memory 74 in association with each other. Further, the association may be realized via time. For example, these two kinds of information can be associated according to a correspondence relationship between time and the information that can determine the position of the lens 13 and a correspondence relationship between time and the information that can determine the contrast evaluation value. The correspondence relationship between time and the information that can determine the position of the lens 13, for example, can be obtained discretely at a certain time interval. Similarly, the correspondence relationship between time and the information that can determine the contrast evaluation value can also be obtained discretely at the certain time interval.

The information that can determine the position of the lens 13 may also be obtained by the determination circuit 84 monitoring the information obtained by the obtaining circuit 81 and calculating at a preset time interval. Further, the information that can determine the contrast evaluation value of the image obtained by the obtaining circuit 81 may be obtained by the detection circuit 83 monitoring the information obtained by the obtaining circuit 81 and calculating at the preset time interval. One or both of the detection circuit 83 and the determination circuit 84 may also perform respective calculations based on the information stored in the memory 74 in this manner.

The focusing circuit 85 controls the drive of the DC motor 61 through the movement control circuit 82 to move the lens 13 to the position of the lens 13 determined by the determination circuit 84, that is, the position of the lens 13 at the time when the peak value of the contrast evaluation value is obtained.

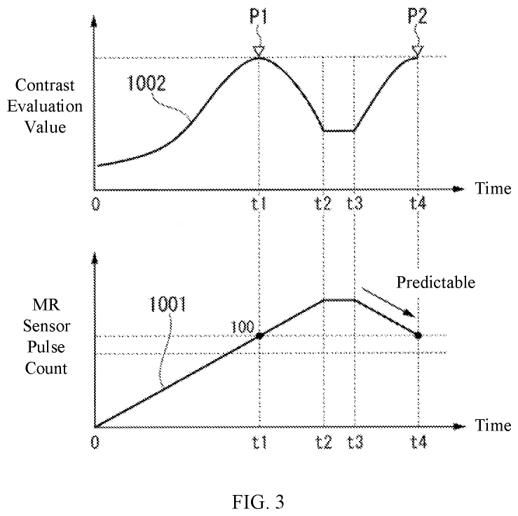

FIG. 3 is an example for explaining autofocus processing performed by the photographing device 1 according to an embodiment of the disclosure. In FIG. 3, horizontal axes represent time and vertical axes represent pulse count characteristics 1001 indicating a pulse count of the MR sensor 41 with respect to time and contrast characteristics 1002 indicating a contrast evaluation value with respect to time.

In the example shown in FIG. 3, time 0 is taken as an origin, and time t1 to time t4 are shown in a temporal sequence. In the photographing device 1, at time 0, a pulse count is set to zero. From time 0, the movement control circuit 82 of the photographing device 1 controls a drive of the DC motor 61 to rotate the gear 62 at a certain speed in a preset rotation direction. At time t2 after a peak value of the contrast evaluation value occurs at time t1, the detection circuit 83 of the photographing device 1 detects the peak value. Then the determination circuit 84 of the photographing device 1 determines a position of the lens 13 at the time when the peak value occurs. Correspondingly, the focusing circuit 85 of the photographing device 1 controls the drive of the DC motor 61 through the movement control circuit 82 around time t2 to temporarily stop the gear 62. The focusing circuit 85 of the photographing device 1 controls the drive of the DC motor 61 through the movement control circuit 82 to rotate the gear 62 at a certain speed in a direction opposite to the preset rotation direction. Then, the focusing circuit 85 of the photographing device 1 makes the lens 13 move to the position at which the peak value occurs and stop according to the pulse count detected by the MR sensor 41. Therefore, the photographing device 1 realizes a focused state at time t4. In some embodiments, the rotation speed of the gear 62 is the same regardless of the rotation direction.

In the example shown in FIG. 3, the contrast evaluation value starts to increase from time 0, reaches a peak value at time t1, and becomes a maximum value. Then, the contrast evaluation value gradually decreases from time t1 to time t2. The detection circuit 83 of the photographing device 1 detects the contrast evaluation value at the time t1 as the peak value, and stores the position of the lens 13 at the time t1 as a detection focus point P1 in the memory 74. The contrast evaluation value does not change due to gear backlash from time t2 to time t3. The contrast evaluation value starts to increase from time t3, and reaches a maximum value that is close to the peak value at time t4. Theoretically, the contrast evaluation value at time t4 is the same as the contrast evaluation value at the detection focus point P1. In the photographing device 1, the position of the lens 13 at time t4 is set as a focus point P2.

In some embodiments, the position of the lens 13 is controlled so that the pulse count (=100) at the detection focus point P1 and the pulse count (=100) at the focus point P2 are same. Therefore, in the photographing device 1, in a state where the lens 13 moves in a preset movement direction and passes the detection focus point P1 where the contrast evaluation value is the peak value, the position of the lens 13 where the contrast evaluation value becomes the peak value can be predicted. Therefore, in the photographing device 1, the lens 13 is moved in an opposite direction so that the position of the lens 13 can directly become coincident with a position of the lens 13 that serves as the focus point P2.

In the example shown in FIG. 3, from time 0 to time t3, the photographing device 1 controls the drive of the DC motor 61 to move the lens 13 while referring to a rotation amount detected by the rotation sensor 63. From time t3 to time t4, according to the pulse count detected by the MR sensor 41, the photographing device 1 controls the drive of the DC motor 61 to control the position of the lens 13 so that the pulse count is the same as a detected pulse count at the detection focus point P1.

In some embodiments, the pulse count detected by the MR sensor 41 becomes a discrete value. Therefore, the determination circuit 84 may, for example, directly use the pulse count detected by the MR sensor 41 to determine the position of the lens 13. Further, the determination circuit 84 may, for example, perform interpolation processing on the pulse count detected by the MR sensor 41 to determine the position of the lens 13. A manner of interpolating the pulse count to determine the position of the lens 13 may be any manner. As an interpolation manner, for example, the pulse count at a midpoint of an exposure time can be calculated in association with the peak value according to the exposure time (shutter speed). As another interpolation manner, for example, when a rolling shutter is used, the pulse count at a time corresponding to a point equivalent to an AF coordinate is calculated in association with the peak value according to a frame rate or the like.

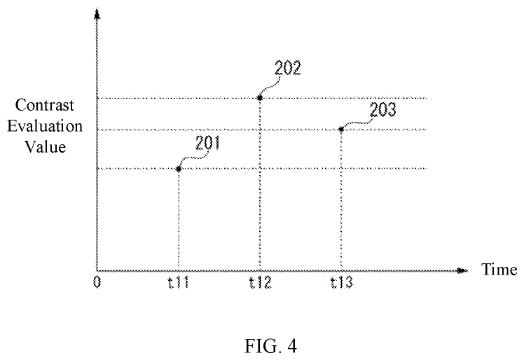

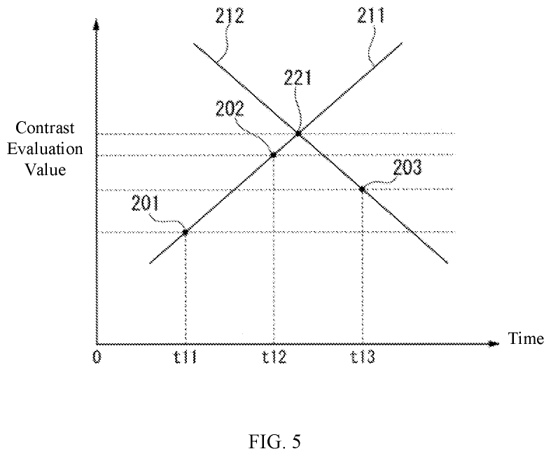

FIG. 4 and FIG. 5 show an example for explaining detection processing of a peak value of a contrast evaluation value performed by a photographing device 1 according to an embodiment of the disclosure. In FIG. 4, a horizontal axis represents time and a vertical axis represents the contrast evaluation value. The contrast evaluation value is a contrast evaluation value calculated by the detection circuit 83. In the example shown in FIG. 4, time 0 is taken as an origin, and time t11 to time t13 are shown in a temporal sequence. Time t11 to time t13 are set in an order of time going forward and have a certain interval.

In the photographing device 1, at time t11 to time t13, points 201 to 203 representing respective contrast evaluation values are obtained. The detection circuit 83 of the photographing device 1 assumes that as the time goes forward, the contrast evaluation value of the second point 202 is greater than the contrast evaluation value of the first point 201 and the contrast evaluation value of the third point 203 is less than the contrast evaluation value of the second point 202. When three points satisfying this condition are detected, the photographing device 1 determines that there is a peak value of the contrast evaluation value between the first point 201 and the third point 203. In the example shown in FIG. 4, such conditions are satisfied.

Further, the detection circuit 83 of the photographing device 1 determines which one is greater between an absolute value of a slope of a straight line passing through the first point 201 and the second point 202 and an absolute value of a slope of a straight line passing through the second point 202 and the third point 203. Then, the detection circuit 83 of the photographing device 1 selects a straight line with a greater absolute value of the slope. In the example shown in FIG. 4, the absolute value of the slope of the straight line passing through the first point 201 and the second point 202 is greater, and this straight line is selected. Further, when the absolute values of the slopes of the two straight lines are the same, either one may be selected.

Further, the detection circuit 83 of the photographing device 1 calculates an intersection point of the selected straight line and a straight line that has a slope being a negative of the slope of the selected straight line and passes through the remaining one point. In the example shown in FIG. 5, the selected straight line is straight line 211. The straight line that has a slope being a negative of the slope of the straight line 211 and passes through the remaining one point, that is, the third point 203, is straight line 212. The intersection point of the two straight lines is the intersection point 221. These two straight lines 211 and 212 pass through the intersection point 221, and are symmetrical with respect to a straight line parallel to the vertical axis.

Further, the detection circuit 83 of the photographing device 1 determines that the calculated intersection point 221 is a point where the contrast evaluation value is a peak value. In the photographing device 1, by performing such detection processing of the peak value of the contrast evaluation value, it is possible to detect a point where the contrast evaluation value is the peak value in a short processing time with simple calculation.

Further, when the contrast evaluation value of the second point and the contrast evaluation value of the third point are the same, for example, the detection circuit 83 of the photographing device 1 further obtains contrast evaluation values after a fourth point until a contrast evaluation value less than these contrast evaluation values is found. Then, the detection circuit 83 of the photographing device 1 determines a point where the contrast evaluation value is a peak value according to the obtained points.

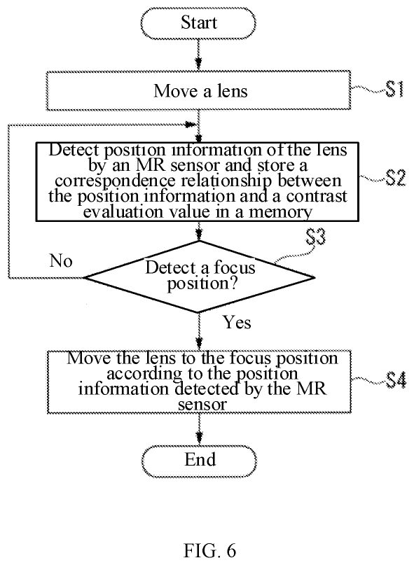

FIG. 6 is a flowchart of a process of autofocus processing performed by a photographing device 1 according to an embodiment of the disclosure.

At S1, a movement control circuit 82 of the photographing device 1 controls a DC motor 61 to drive a gear 62 to rotate. Therefore, the movement control circuit 82 of the photographing device 1 moves a lens 13 in a preset direction along an axis D1.

At S2, during a movement of the lens 13, information detected by the MR sensor 41 for determining the position of the lens 13 is stored in a memory 74. In some embodiments, a pulse count is used as the information for determining the position of the lens 13. A correspondence relationship between the pulse count and a contrast evaluation value is stored in the memory 74.

At S3, it is determined whether a detection circuit 83 of the photographing device 1 has detected a focus position at which the contrast evaluation value is a peak value. If it is determined that the detection circuit 83 of the photographing device 1 detects the peak value of the contrast evaluation value (S3: Yes), the process proceeds to process S4. In some embodiments, if it is determined that the detection circuit 83 of the photographing device 1 has not detected the peak value of the contrast evaluation value (S3: No), the process proceeds to process S2.

At S4, a determination circuit 84 of the photographing device 1 determines the position of the lens 13 at which the contrast evaluation value is the peak value as the focus position according to the information detected by the MR sensor 41 for determining the position of the lens 13. Then, according to a state where the lens 13 has passed a point corresponding to the peak value in one preset direction, a focusing circuit 85 of the photographing device 1 moves the lens 13 in a direction opposite to the one direction through the movement control circuit 82. The focusing circuit 85 of the photographing device 1 makes the lens 13 move to the focus position and stop. The processing of this process ends. Further, when a controller 75 detects the focus position, a correspondence relationship between the contrast evaluation value and the position of the lens 13 may be stored in the memory 74.

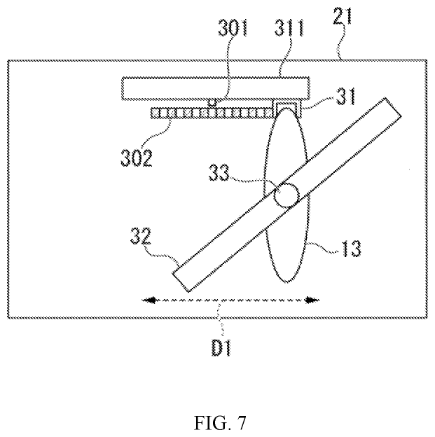

FIG. 7 is a diagram showing a configuration of an MR sensor 301 and a magnetic member 302 of a photographing device 1 according to an embodiment of the disclosure. FIG. 7 shows a configuration of a lens barrel 12 according to a variation example. In the example shown in FIG. 7, compared with the example shown in FIG. 2, a disposition position of the magneto resistive effect device, e.g., the MR sensor 301, and a disposition position of the magnetic member 302 are different, and the other features are the same. In the example shown in FIG. 7, a lens frame 31 is disposed at the magnetic member 302. Further, in the example shown in FIG. 7, the lens frame 31 is fixed to the magnetic member 302. Further, in the example shown in FIG. 7, the MR sensor 301 is disposed at a guide shaft 311. In the example shown in FIG. 7, the MR sensor 301 is fixed to the guide shaft 311. The guide shaft 311 includes a mechanism that moves the lens frame 31 in a direction of an optical axis of a lens 13. With such a configuration, similarly to the configuration shown in FIG. 2, the MR sensor 301 can also detect information for determining a position of the lens 13. In the example shown in FIG. 7, the magneto resistive effect device, that is the MR sensor 301, and the magnetic member 302 constitute a position detector that detects the position of the lens 13.

As described above, in the photographing device 1 according to some embodiments, the lens 13 is moved in one direction and a peak value of a contrast evaluation value is detected. In the photographing device 1 according to some embodiments, according to a movement amount detected by the MR sensor 301, the lens 13 is moved in a direction opposite to the one direction until a state close to a focused state corresponding to the peak value is reached. Therefore, in the photographing device 1 according to some embodiments, it is possible to shorten the time needed to achieve the focused state in an autofocus control. As a result, in the photographing device 1 according to some embodiments, it is possible to speed up a processing to achieve the focused state by the autofocus control.

Further, in the photographing device 1 according to some embodiments, the MR sensor 301 that can precisely detect the position of the lens 13 is used, and the position of the lens 13 is aligned with a focus position. Therefore, in the photographing device 1 according to some embodiments, an accuracy of the focused state achieved by the autofocus control can be improved. That is, in the photographing device 1 according to some embodiments, by using the MR sensor 301, it is possible to perform a high-accuracy autofocus control.

In some embodiments, a movement control circuit 82 of the photographing device 1 moves the lens 13 in a preset direction (a first direction) along the optical axis. The photographing device 1 obtains an image through the lens 13. A detection circuit 83 of the photographing device 1 obtains the contrast evaluation value of the image. The MR sensor 301 detects information corresponding to the movement amount of the lens 13. In the photographing device 1, a correspondence relationship between the contrast evaluation value and the position of the lens 13 is stored at a memory 74. The detection circuit 83 detects the peak value of the contrast evaluation value of the image obtained from an imaging device 71 with the light passing through the lens 13 while the lens 13 moves in the preset direction. A determination circuit 84 determines a position of the lens 13 at the time when the detection circuit 83 detects the peak value according to the information detected by the MR sensor 301. After the detection circuit 83 detects the peak value, a focusing circuit 85 causes the lens 13 to move in a direction opposite to the preset direction (a second direction opposite to the first direction) through the movement control circuit 82, so that the lens 13 moves to the position of the lens 13 determined by the determination circuit 84. In this way, in the photographing device 1, after a focus position of the lens 13 is detected according to the contrast evaluation value, the correspondence relationship is read from the memory 74, the lens 13 is moved in a direction opposite to the preset direction, and the lens 13 is moved to a position of the lens 13 corresponding to the focus position.

In the photographing device 1 according to some embodiments, the memory 74 stores a correspondence relationship between information that can determine the position of the lens 13 according to information detected by the MR sensor 301 and information that can determine the contrast evaluation value. The determination circuit 84 determines the position of the lens 13 according to the correspondence relationship stored at the memory 74. The focusing circuit 85 causes the lens 13 to move to the position of the lens 13 determined by the determination circuit 84 according to the information detected by the MR sensor 301.

As shown in FIGS. 4 and 5, the detection circuit 83 of the photographing device 1 according to some embodiments detects three points in an order of time going forward. When the contrast evaluation value of a second point 202 is greater than the contrast evaluation value of a first point 201, and the contrast evaluation value of a third point 203 is less than the contrast evaluation value of the second point 202, among a straight line 211 passing through the first point 201 and the second point 202 and a straight line passing through the second point 202 and the third point 203, a straight line with a greater absolute value of the slope is selected (the straight line 211 in the example shown in FIGS. 4 and 5). An intersection point (the intersection point 211 in the example shown in FIG. 5) of the selected straight line and a straight line that passes through the first point 201 or the third point 203 that the selected line does not pass (the third point 203 in the example shown in FIGS. 4 and 5) and has a slope being a negative of the slope of the selected straight line is detected as a point corresponding to the peak value.

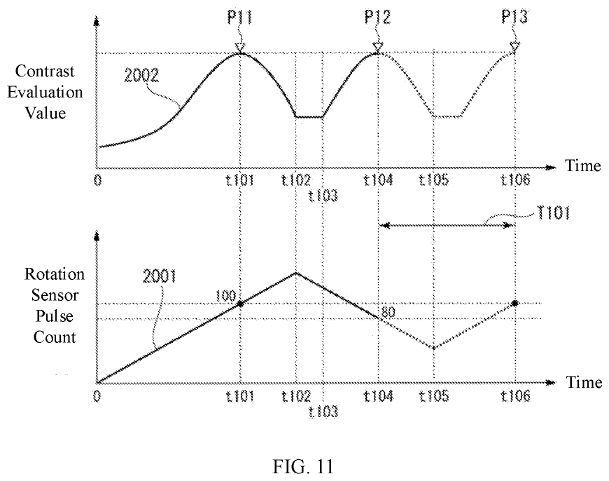

FIG. 11 is a schematic diagram for explaining contrast detection AF. In FIG. 11, a horizontal axis represents time and vertical axes represent a pulse count characteristic 2001 indicating a pulse count of a rotation sensor with respect to time and a contrast characteristic 2002 indicating a contrast evaluation value with respect to time. The rotation sensor includes a two-phase rotation sensor. Further, the rotation sensor counts a number of discrete pulses for detection according to a rotation amount of a gear. The count value is the pulse count. Further, in a photographing device according to the example shown in FIG. 11, the DC motor, the gear, and the rotation sensor, for example, can be the same as the DC motor 61, the gear 62, and the rotation sensor 63, respectively, shown in FIG. 2.

In the example shown in FIG. 11, time 0 is taken as an origin, and time t101 to time t106 are shown in a temporal sequence. In the photographing device, at time 0, the pulse count is set to zero. From time 0, the gear is driven by the DC motor to rotate at a certain speed in a preset rotation direction. Around time t102, after a peak value of the contrast evaluation value occurs at time t101, the photographing device detects the peak value. Correspondingly, around time t102, the photographing device controls the DC motor to temporarily stop the gear. Then the photographing device controls the DC motor to drive the gear to rotate at a certain speed in a direction opposite to the preset rotation direction. Further, the rotation speed of the gear is the same regardless of the rotation direction.

After a peak value of the contrast evaluation value occurs again at time t104, the photographing device detects the peak value around time t105. Correspondingly, around time t105, the photographing device controls the drive of the DC motor to temporarily stop the gear. Then, the photographing device controls the drive of the DC motor to rotate the gears again at the certain speed in the preset rotation direction. Through such climbing control, the photographing device achieves the position of the lens at the time when the peak value of the contrast evaluation value is detected at time t106. Further, FIG. 11 shows a focus point P12 achieved at time t104 and a focus point P13 achieved at time t106 as points theoretically having the same contrast evaluation value as the detection focus point P11.

In the example shown in FIG. 11, the contrast evaluation value starts to increase from time 0, reaches the peak value at time t101, and becomes a maximum value. Then, the contrast evaluation value gradually decreases from time t101 to time t102. The contrast evaluation value does not change due to gear backlash from time t102 to time t103. Then the contrast evaluation value starts to increase from time t103, and reaches a maximum value that is close to the peak value at time t104. Theoretically, the contrast evaluation value at time t104 is the same as the contrast evaluation value at the detection focus point P11.

Further, the contrast evaluation value gradually decreases from time t104 to time t105. The contrast evaluation value does not change due to gear backlash for a short period from time t105. Then, the contrast evaluation value increases and reaches a maximum value that is close to the peak value at time t106. Theoretically, the contrast evaluation value at time t106 is the same as the contrast evaluation value at the detection focus point P11. The photographing device sets the position of the lens at time t106 as the focus point P13.

However, in this contrast detection AF, due to gear backlash, after the gear is controlled by climbing control, it does not correspond with the focus point P12 at time t104. A time interval T101 from time t104 to time t106 is spent on an extra process and is long. Therefore, the time interval T101 from when the lens passes the focus point P12 at time t104 to when the lens is returned to the focus point P13 at time t106 by climbing control becomes a delay time when a focused state is achieved in the autofocus control. In the example shown in FIG. 11, the pulse count characteristic 2001 and the contrast characteristic 2002 are mostly indicated by solid lines, but a portion corresponding to the time interval T101 is indicated by a dotted line.

Further, in this contrast detection AF, due to gear backlash, a shift occurs between the pulse count (=100) at the detection focus point P11 and the pulse count (=80) at the focus point P12. In the photographing device, when the lens is moved to the final focus point P13 at time t106, inertia is used to control the lens to move to an approximate focus point. Therefore, in the photographing device, a deviation occurs at the final focus point, and the accuracy of a focused state achieved by the autofocus control may be poor.

Thus, in the example contrast detection AF shown in FIG. 11, it is needed to perform climbing control to achieve the focused state. Therefore, in the example contrast detection AF shown in FIG. 11, a process of moving the lens in one direction, a process of moving the lens in a direction opposite to the one direction, and a process of moving the lens in the one direction again are needed. Therefore, the time needed for the processing until the focused state is achieved by the autofocus control may become longer. Further, the autofocus control is performed by feeding back the rotation amount of the gear detected by the rotation sensor. However, due to the gear backlash, the accuracy of the focused state achieved by the autofocus control may be poor.

In contrast, in the photographing device 1 according to some embodiments of the present disclosure, the focused state can be achieved by a process of moving the lens 13 in one direction and a process of moving the lens 13 in a direction opposite to the one direction. Therefore, in the photographing device 1 according to some embodiments, the processes of operations can be reduced, and the processing needed for achieving the focused state by the autofocus control can be shortened. Further, in the photographing device 1 according to some embodiments, the accuracy of the focused state achieved by the autofocus control can be improved by using the MR sensor 41.

In some embodiments, because a magnetic mechanism including the MR sensor 41 and the magnetic member 42 is disposed around the lens, the magnetic mechanism can be applied to a medium-sized photographing device that includes a large lens compared to a small-sized photographing device. That is, compared with the small-sized photographing device, the medium-sized photographing device often has a larger space where the magnetic mechanism according to some embodiments can be installed, which is particularly effective when a large lens is driven.

For example, the photographing device 1 may include a step motor instead of the DC motor 61. In this scenario, the step motor is controlled by the controller 75 to rotate the gear 62. Then, the lens 13 is driven through the step motor. Further, like the DC motor 61, the step motor may also have positional error, but the photographing device 1 according to some embodiments can eliminate this defect.

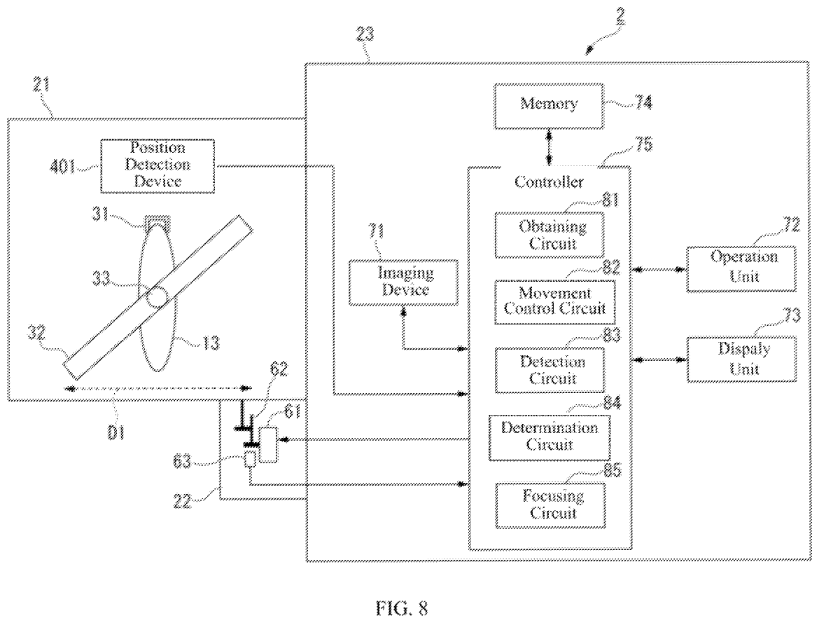

Some other embodiments will be described with reference to FIG. 8. FIG. 8 is another schematic diagram showing a functional configuration of a photographing device 2 according to an embodiment of the disclosure. Compared with the photographing device 1 shown in FIG. 2, the photographing device 2 shown in FIG. 8 replaces the MR sensor 41 and the magnetic member 42 disposed around the lens 13 with a position detection device 401 disposed around the lens 13 other than the MR device. For other parts, the configuration of the photographing device 2 shown in FIG. 8 is the same as the configuration of the photographing device 1 shown in FIG. 2, and the same reference numerals are used for description.

The position detection device 401 includes, for example, a device that directly detects the position of the lens 13 using the lens 13 itself or a device or a unit that moves together with the lens 13. The position detection device 401 may include any device that can uniquely determine the position of the lens 13. The position detection device 401 may include, for example, a sensor that uses a Hall device, a sensor that detects the position of the lens 13 through a voltage division of a variable resistor, a sensor that detects the position of the lens 13 through a pattern of a hologram, or a sensor that detects the position of the lens 13 through light, etc.

The Hall device is a device that uses the Hall effect to detect a magnetic field. The sensor using the Hall device includes, for example, a Hall device and a magnetic member 42 instead of the MR sensor 41 and the magnetic member 42 shown in FIG. 2. This sensor detects information that can determine the position of the lens 13 based on a relative position of the Hall device and the magnetic member 42. The sensor that detects the position of the lens 13 through the voltage division of the variable resistor includes, for example, a variable resistor whose resistance value is configured to change with the position of the lens 13, and a detection unit that detects the resistance value of the variable resistor by the voltage division, which replace the MR sensor 41 and the magnetic member 42 shown in FIG. 2. The sensor detects information that can determine the position of the lens 13 based on the voltage division detected by the detection unit.

The sensor that detects the position of the lens 13 through the pattern of the hologram includes, for example, a mechanism in which the pattern of the hologram changes with the position of the lens 13. The sensor detects information that can determine the position of the lens 13 based on the pattern. The sensor that detects the position of the lens 13 through light includes, for example, a light emitter that emits light and a light receiver in which light-receiving device that receive the light are arranged along the axis D1 of the lens 13, which replace the MR sensor 41 and the magnetic member 42 shown in FIG. 2. The sensor detects information that can determine the position of the lens 13 based on the light-receiving device of the light receiver that receives the light from the light emitter.

In this way, in the photographing device 2, when the position detection devices 401 replaces the MR sensor 41 and the magnetic member 42 shown in FIG. 2, the processes of lens movement needed for the autofocus control can also be reduced. That is, in the photographing device 2, the contrast evaluation value of the image obtained by the imaging device 71 is detected while the lens 13 moves in one direction. Then, when the contrast evaluation value increases to the peak value and then decreases, the photographing device 2 moves the lens 13 in a direction opposite to the one direction, and controls the lens 13 to move to the focus position based on a detection value of the position detection device 401.

In some embodiments, the movement control circuit 82 of the photographing device 2 moves the lens 13 along the optical axis. The position detection device 401 detects information corresponding to the movement amount of the lens 13. The detection circuit 83 detects the peak value of the contrast evaluation value of the image obtained by the imaging device 71 with the light passing through the lens 13 during the movement of the lens 13 in the preset direction. The determination circuit 84 determines the position of the lens 13 at the time when the peak value is detected by the detection circuit 83 according to the information detected by the position detection device 401. After the detection circuit 83 detects the peak value, the focusing circuit 85 causes the lens 13 to move in a direction opposite to the preset direction through the movement control circuit 82, and causes the lens 13 to move to the position of the lens 13 determined by the determination circuit 84.

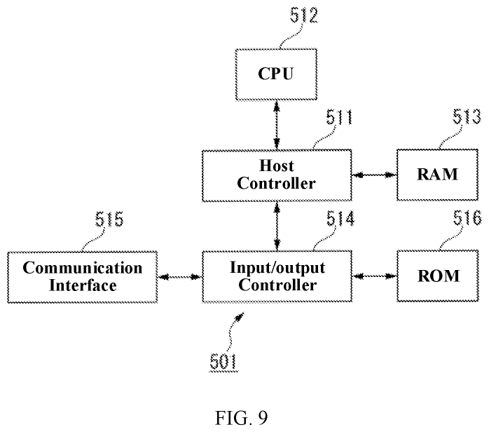

FIG. 9 is a diagram of a hardware configuration of a controller 75 and a memory 74. For example, a computer 501 may be an apparatus including the controller 75 and the memory 74. The computer 501 includes a host controller 511, a central processing unit (CPU) 512, a random-access memory (RAM) 513, an input/output controller 514, a communication interface 515, and a read-only memory (ROM) 516. In the example shown in FIG. 2, the memory 74 may be the RAM 513 or the ROM 516.

The host controller 511 is connected to the CPU 512, the RAM 513, and the input/output controller 514, and connects them to each other. Further, the input/output controller 514 is connected to the communication interface 515 and the ROM 516, and connects them to the host controller 511. The CPU 512 executes various processing or control by reading and executing programs stored in the RAM 513 or ROM 516. The communication interface 515 communicates with other devices via a network, for example. In the example shown in FIG. 2, other devices may be the imaging device 71, the operation unit 72, the display unit 73, the DC motor 61, the rotation sensor 63, or the MR sensor 41.

For example, a computer-readable recording medium (storage medium) may record a program for realizing the functions of various devices (for example, the photographing devices 1, 2, etc.) according to some embodiments, and the computer system may read and execute the program recorded on the recording medium for processing. Further, the “computer system” may include hardware including an operating system (OS) or peripheral devices. Further, the “computer-readable recording medium” includes a writable non-volatile memory such as a flexible disk, an optical disk, a ROM, a flash memory, or the like, or a storage device such as a movable medium such as a digital versatile disc (DVD), or the like, or a hard disk built into a computer system. Further, the recording medium may be a recording medium that temporarily records data.

Furthermore, the “computer-readable recording medium” may also include a device that retains a program for a certain period of time, such as a volatile memory (such as dynamic random access memory (DRAM)) in the computer system of a server or client machine when the program is transmitted via a communication line such as the internet or a telephone line. Further, the above-described program may be transferred from a computer system storing the program in a storage device or the like to another computer system via a transmission medium or a transmission wave in the transmission medium. The “transmission medium” that transmits the program refers to a medium having a function of transmitting information such as a network (communication network) such as the Internet or a communication link (communication line) such as a telephone line. Further, the above-described program can also be used to realize a part of the aforementioned functions. Furthermore, the aforementioned program may be a differential file (a differential program) that realizes the aforementioned functions by combining with a program already recorded in the computer system.

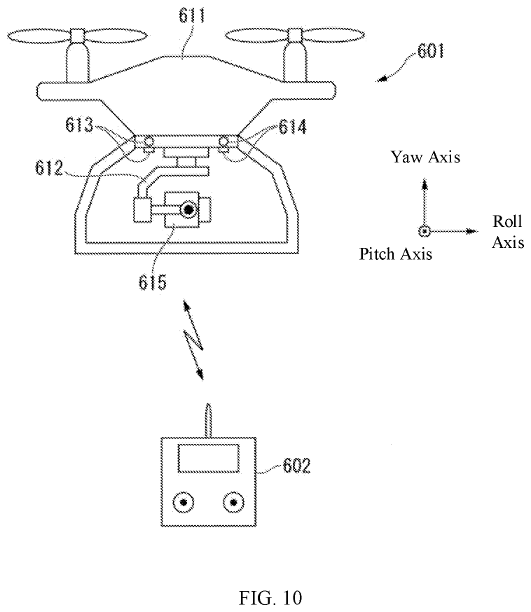

FIG. 10 is a schematic diagram showing an unmanned aerial vehicle (UAV) 601 and a remote operation device 602. The UAV 601 includes a UAV body 611, a gimbal 612, and a plurality of photographing devices 613-615. The UAV 601 is an example of a flight body that flies with the assist of rotors. The flight body can include an aircraft movable in the air.

The UAV body 611 includes a plurality of rotors. The UAV body 611 causes the UAV 601 to fly by controlling rotations of the plurality of rotors. The UAV body 611 uses, for example, four rotors to make the UAV 601 fly. The number of rotors is not limited to four.

The photographing device 615 is a camera for shooting a target object included in a desired shooting range. The gimbal 612 supports the photographing device 615 so that a pose of the photographing device 615 can be changed. The gimbal 612 supports the photographing device 615 in a rotatable manner. For example, the gimbal 612 uses an actuator to support the photographing device 615 in a manner that can rotate around a pitch axis. Further, the gimbal 612 uses actuators to support the photographing device 615 in a manner that can rotate around a roll axis and a yaw axis, respectively. The gimbal 612 can also change the pose of the photographing device 615 by rotating the photographing device 615 around at least one of the yaw axis, the pitch axis, or the roll axis.

The photographing device 613 and the photographing device 614 are sensing cameras that shoot surroundings of the UAV 601 in order to control the flight of the UAV 601. The two photographing devices 613 and 614 can be disposed at the nose or front of the UAV 601. Moreover, two other photographing devices (not shown in the figure) can also be disposed at a bottom surface of the UAV 601. The two photographing devices 613 and 614 at the front side are paired to function as stereo camera. The two photographing devices (not shown) at the bottom side are also paired to function as stereo camera.

According to the images captured by the photographing device 613 and the photographing device 614, three-dimensional spatial data around the UAV 601 can be generated. The number of photographing devices 613 and 614 included in the UAV 601 is not limited to four. The UAV 601 may include at least one photographing device 613, and one photographing device 614. The UAV 601 may also include at least one photographing device 613 and one photographing device 614 at the nose, tail, sides, bottom surface, and top surface of the UAV 601, respectively. An angle of view that can be set by the photographing devices 613 and 614 may be greater than an angle of view that can be set by the photographing device 615. In other words, the shooting range of the photographing devices 613 and 614 may be wider than the shooting range of the photographing device 615. The photographing devices 613 and 614 may include a single focus lens or a fisheye lens.

The remote operation device 602 communicates with the UAV 601 and performs remote operations on the UAV 601. The remote operation device 602 can also communicate with the UAV 601 wirelessly. The remote operation device 602 transmits various drive commands related to the movement of the UAV 601 such as ascending, descending, accelerating, decelerating, going forward, going backward, and rotating to the UAV 601. The UAV 601 receives a command sent from the remote operation device 602, and executes various processes in accordance with the command. In some embodiments, for example, the photographing device 1 shown in FIG. 2 or the photographing device 2 shown in FIG. 8 may be used as one or more of the photographing devices 613 to 615 shown in FIG. 10.

The present disclosure has been described above using embodiments, but the technical scope of the present disclosure is not limited to the scope described in the above embodiments. It is obvious to those skilled in the art that various changes or improvements can be made to the above-described embodiments. All such changes or improvements can be included in the scope of the present disclosure.

The present disclosure further provides a method including processes executed by the photographing device 1 and/or the photographing device 2. The present disclosure also provides a program executable by a processor of a computer that implementing the photographing device 1 and/or the photographing device 2.

What is claimed is:

1. A control device comprising:
a position detector; and
a controller configured to:
control a lens to move along an optical axis in a first direction;
obtain one or more images through the lens while the lens is moving along the optical axis in the first direction;
obtain one or more contrast evaluation values each corresponding to one of the one or more images;
obtain, via the position detector, one or more lens positions each corresponding to one of the one or more images;
store a correspondence relationship between the one or more contrast evaluation values and the one or more lens positions in a memory; and
in response to detecting a focus position of the lens according to the one or more contrast evaluation values:
read the correspondence relationship from the memory; and
control the lens to move in a second direction opposite to the first direction until the lens is moved to a lens position corresponding to the focus position.

2. The control device of claim 1, wherein the position detector includes:
a magneto resistive effect device disposed at a lens frame that fixes the lens; and
a magnetic member including one or more first units and one or more second units arranged alternately along the optical axis, each of the one or more first units having a first polarity and each of the one or more second units having a second polarity different from the first polarity.

3. The control device of claim 2, wherein a length of the magnetic member is longer than a sum of a movable range of the lens and an amount of a gear backlash caused by lens movement.

4. The control device of claim 1, wherein the position detector includes:
a magnetic member including one or more first units and one or more second units arranged alternately along the optical axis, each of the one or more first units having a first polarity and each of the one or more second units having a second polarity different from the first polarity;
a lens frame disposed at the magnetic member; and
a magneto resistive effect device disposed at a guide configured to cause the lens frame to move along the optical axis.

5. The control device of claim 4, wherein a length of the magnetic member is longer than a sum of a movable range of the lens and an amount of a gear backlash caused by lens movement.

6. The control device of claim 1, wherein the controller is further configured to store the correspondence relationship in the memory in response to the focus position being detected.

7. The control device of claim 1, further comprising:
a gear link mechanism configured to move the lens.

8. The control device of claim 1, further comprising:
a direct current (DC) motor or a step motor configured to drive the lens to move.

9. A control method comprising:
controlling a lens to move along an optical axis in a first direction;
obtaining one or more images through the lens while the lens is moving along the optical axis in the first direction;
obtaining one or more contrast evaluation values each corresponding to one of the one or more images;
obtaining, via a position detector, one or more lens positions each corresponding to one of the one or more images;
storing a correspondence relationship between the one or more contrast evaluation values and the one or more lens positions in a memory; and
in response to detecting a focus position of the lens according to the one or more contrast evaluation values:
reading the correspondence relationship from the memory; and
controlling the lens to move in a second direction opposite to the first direction until the lens is moved to a lens position corresponding to the focus position.

10. The control method of claim 9, wherein the position detector includes:
a magneto resistive effect device disposed at a lens frame that fixes the lens; and
a magnetic member including one or more first units and one or more second units arranged alternately along the optical axis, each of the one or more first units having a first polarity and each of the one or more second units having a second polarity different from the first polarity.

11. The control method of claim 10, wherein a length of the magnetic member is longer than a sum of a movable range of the lens and an amount of a gear backlash caused by lens movement.

12. The control method of claim 9, wherein the position detector includes:
a magnetic member including one or more first units and one or more second units arranged alternately along the optical axis, each of the one or more first units having a first polarity and each of the one or more second units having a second polarity different from the first polarity;
a lens frame disposed at the magnetic member; and
a magneto resistive effect device disposed at a guide configured to cause the lens frame to move along the optical axis.

13. The control method of claim 12, wherein a length of the magnetic member is longer than a sum of a movable range of the lens and an amount of a gear backlash caused by lens movement.

14. The control method of claim 9, wherein storing a correspondence relationship in the memory includes storing the correspondence relationship in the memory in response to the focus position being detected.

15. The control method of claim 9, wherein controlling the lens to move includes controlling the lens to move via a gear link mechanism.

16. The control method of claim 9, wherein controlling the lens to move includes driving the lens to move via a direct current (DC) motor or a step motor.

17. A non-transitory computer-readable storage medium storing a program that, when executed by a computer, causes the computer to:
control a lens to move along an optical axis in a first direction;
obtain one or more images through the lens while the lens is moving along the optical axis in the first direction;
obtain one or more contrast evaluation values each corresponding to one of the one or more images;
obtain, via a position detector, one or more lens positions each corresponding to one of the one or more images;
store a correspondence relationship between the one or more contrast evaluation values and the one or more lens positions in a memory; and
in response to detecting a focus position of the lens according to the one or more contrast evaluation values:
read the correspondence relationship from the memory; and
control the lens to move in a second direction opposite to the first direction until the lens is moved to a lens position corresponding to the focus position.

18. The storage medium of claim 17, wherein the position detector includes:
a magneto resistive effect device disposed at a lens frame that fixes the lens; and
a magnetic member including one or more first units and one or more second units arranged alternately along the optical axis, each of the one or more first units having a first polarity and each of the one or more second units having a second polarity different from the first polarity.

19. The storage medium of claim 18, wherein a length of the magnetic member is longer than a sum of a movable range of the lens and an amount of a gear backlash caused by lens movement.

20. The storage medium of claim 17, wherein the position detector includes:
a magnetic member including one or more first units and one or more second units arranged alternately along the optical axis, each of the one or more first units having a first polarity and each of the one or more second units having a second polarity different from the first polarity;
a lens frame disposed at the magnetic member; and
a magneto resistive effect device disposed at a guide configured to cause the lens frame to move along the optical axis.
